(19) United States
(12) Patent Application Publication
(10) Pub. No.: US 2024/0163402 A1
(43) Pub. Date: May 16, 2024

(54) SYSTEM, APPARATUS, AND METHOD OF SURVEILLANCE

(71) Applicants: Daniel KARIO, Ocean Shores (AU); Nir LEVY, Hod Hasharon (IL)

(72) Inventors: Daniel KARIO, Ocean Shores (AU); Nir LEVY, Hod Hasharon (IL)

(21) Appl. No.: 18/282,205

(22) PCT Filed: Jun. 15, 2022
(86) PCT No.: PCT/IB2022/055538

§ 371 Date: Sep. 14, 2023

Related U.S. Application Data
(60) Provisional application No. 63/212,546, filed on Jun. 18, 2021.

(51) Int. Cl. H04N 7/18; G06V 10/77; G06V 20/54; G06V 20/58; G06V 20/62

(52) U.S. Cl. CPC H04N 7/181; G06V 10/77; G06V 20/54; G06V 20/58; G06V 20/625

(57) ABSTRACT

Disclosed herein are systems, apparatuses, devices, and methods for surveillance. In at least some embodiments, a surveillance unit is disclosed that is configured to function as a stand-alone detection and/or surveillance unit; that is, it functions without a network or external power. The surveillance unit may be configured to detect and/or surveil vehicles, including vehicles without license plates (e.g., motorcycles or motorbikes without license plates displayed in the front of the motorcycle or motorbike, respectively. The surveillance unit may further be configured to save and/or store one or more images of one or more detected and/or surveilled vehicles (e.g., a specific motorcycle or motorbike) at selected frames over time and compare the one or more images to one or more previously-taken images for similarity.

### FIELD

The application relates generally to surveillance, and particularly to systems, devices, apparatuses, and methods of surveillance.

### BACKGROUND

Surveillance systems and devices are used by, among others, law enforcement agencies and private security companies. They can be used for a variety of functions, including locating an individual in the field. Such systems and devices may be used when location of an individual is particularly difficult, e.g., due to risk, cost, technical issues with other solutions, etc., and/or when communications to a central location may not be effective or possible, e.g., due to technical reasons, financial reasons, the risk of detection, and the like.

One example of a surveillance system known in the art is the Static License Plate Recognition (LPR) system, which is used in parking lots and traffic toll booths, among other places, to detect license plates using a fixed angle and/or known angles.

One other example of a surveillance system known in the art is the “Store and forward” video system. The “Store and forward” video system is configured to capture video, store the video, and either (1) transmit the video to a central location (e.g., headquarters of a law enforcement agency) and/or a cloud-based location, and/or (2) store the raw material for further processing at law enforcement agency laboratories. Disadvantageously, this system does not process the collected information at or within the surveillance device itself.

A further example of a surveillance system known in the art is the mobile LPR system for traffic enforcement, which is often used mainly by police agencies. Disadvantageously, the mobile LPR system uses a power source. While it can do some processing within the unit itself, it assumes a vehicle is either not moving or that the camera is located at the front. A further disadvantage is that the mobile LPR system cannot identify certain vehicles (e.g., motorcycles or motorbikes) that have no license plate displayed.

A still further example of a surveillance system known in the art is a wireless network (WiFi) mapping system. WiFi mapping systems often include stand-alone devices and are configured to map WiFi devices, access points, and the like. Disadvantageously, the WiFi mapping device works only on networks, and there is no crossing of information from visual sensors to the WiFi network device.

Given the foregoing, there exists a significant need for systems, apparatuses, devices, and/or methods of surveillance that mitigate the above-mentioned disadvantages.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. Rather, the scope of the invention is defined by the appended claims.

In certain embodiments, the disclosed embodiments may include one or more of the features described herein.

In general, the present disclosure is directed to systems, apparatuses, devices, and methods for surveillance. In at least some embodiments, a system for detection and/or surveillance comprises one or more surveillance units for surveilling an area, wherein each of the one or more surveillance units comprises: one or more visual sensors configured to obtain one or more images of a target in the area, one or more audio sensors configured to obtain audio of the area, one or more location sensors configured to obtain positional data regarding the target and/or the area, and/or one or more network sensors and/or one or more antennas operably connected to one or more WiFi cards and/or one or more Bluetooth cards, one or more dongles configured to communicate with one or more external networks, one or more data storage devices, one or more cooling units, and one or more clocks and/or timers.

In at least one embodiment, the surveillance unit need not have at least one of each sensor type (i.e., visual sensor, audio sensor, location sensor, network sensor, Bluetooth sensor, WiFi sensor) described above. As a non-limiting example, the surveillance unit can perform one or more of the methods described herein using only a visual sensor and a WiFi sensor, without any of the other sensor types (e.g., audio sensor)

In at least one embodiment, the aforementioned target is selected from the group consisting of: a vehicle, a portion of a vehicle, a person, an animal, a ship or other watercraft, and combinations thereof.

In at least one embodiment, the one or more images include information selected from the group consisting of: a vehicle's make, a vehicle's model, a vehicle's color, and a vehicle's license plate.

In at least one embodiment, each of the one or more surveillance units further comprises one or more movement sensors configured to detect movement of at least one of the one or more surveillance units.

Additionally, each of the one or more surveillance units may further comprise at least one computer comprising at least one processor operatively connected to at least one non-transitory, computer readable medium, the at least one non-transitory computer readable medium having computer-executable instructions stored thereon, wherein, when executed by the at least one processor, the computer executable instructions carry out a set of steps comprising: performing surveillance on the target and/or the area over a predetermined period of time, identifying the target and one or more properties of the target based on data gathered at a first point in time in the predetermined period of time, and identifying the target at a second point in time in the predetermined period of time based on the one or more properties.

In at least one embodiment, the step of identifying the target and one or more properties of the target is performed using one or more artificial intelligence (AI) processes.

In at least one embodiment, the target comprises a motorcycle rider, and the one or more properties of the target is selected from the group consisting of: a helmet, one or more portions of a motorcycle being ridden by the motorcycle rider, a wireless signature of an electronic device of the motorcycle rider, and combinations thereof.

In at least one embodiment, the set of steps further comprises: identifying the target at the second point in time by comparing (i) one or more image frames and/or features captured at the first point in time and one or more image frames and/or features captured at the second point in time with (ii) historical data stored on the one or more data storage devices.

In at least one embodiment, the data gathered at the first point in time comprises the one or more images, and the one or more images may include one or more portions of a vehicle other than the vehicle's license plate.

In at least one embodiment, the target is a person surveilling at least one of the one or more surveillance units.

In at least one embodiment, at least one of the one or more surveillance units is a surveillance device that is configured to operate without connection to a power grid. In at least a further embodiment, the surveillance device is placed in a moving vehicle, the area is an area behind the moving vehicle, the target is a pursuing vehicle traveling in the area behind the moving vehicle and/or a person inside the pursing vehicle, and the one or more images include a license plate of the pursuing vehicle.

In at least one embodiment, two or more surveillance units are used in conjunction to monitor and/or surveil one or more locations, and gathered data collected from any one of the two surveillance units is shared with the other surveillance unit. For instance, surveillance unit A surveying area A can identify a target (e.g., a vehicle with an unknown license plate) and transmit the gathered data on the target, as well as any identifying features of the target (e.g., vehicle make and model, vehicle color) to surveillance unit B that is surveying area B. If the vehicle then enters area B, surveillance unit B can identify the target and track the target. Accordingly, two or more surveillance units can be used together to identify and track, for instance, a vehicle that has visited two different gas stations, located in two different places, within a certain period of time (e.g., one hour).

In at least a further embodiment, a surveillance device is disclosed that comprises at least one computer comprising at least one processor operatively connected to at least one non-transitory, computer readable medium, the at least one non-transitory computer readable medium having computer-executable instructions stored thereon, wherein, when executed by the at least one processor, the computer executable instructions carry out a set of steps comprising: observing, by at least one visual sensor comprised on the surveillance device, an area; capturing, by the at least one visual sensor, one or more images of the area at a first point in time; identifying, by the at least one processor, both a two-wheeled vehicle and one or more properties of the two-wheeled vehicle based on the one or more images; and identifying, by the at least one processor, the two-wheeled vehicle in the area at a second point in time based on the one or more properties. In at least one embodiment, the one or more properties does not comprise a license plate of the two-wheeled vehicle.

In at least one embodiment, the set of steps further comprises: collecting, by one or more network sensors and/or one or more antennas operably connected to one or more WiFi and/or one or more Bluetooth cards comprised in the surveillance device, a WiFi identifier and/or a Bluetooth identifier from a person operating the two-wheeled vehicle; and identifying, by the at least one processor, the person based on the WiFi identifier and/or the Bluetooth identifier.

In at least one embodiment, the one or more properties comprises a combination of one or more features of the two-wheeled vehicle and one or more features of the person.

In at least one embodiment, the computer executable instructions further define: a user interface engine configured to generate and display a user interface for the surveillance device, a communications engine configured to communicate with (i) the user interface engine, and (ii) a remote user of the surveillance device, a vision processing engine configured to capture one or more images from the at least one visual sensor, an audio processing engine configured to capture audio from at least one audio sensor comprised in the surveillance device, and a system manger configured to communicate with, and obtain data from, the vision processing engine and the audio processing engine.

In at least one embodiment, the vision processing engine and the audio processing engine are both operably connected to one or more data repositories comprised in the surveillance device.

In at least one embodiment, the surveillance device further comprises one or more batteries that provide a sole source of power for the surveillance device.

In at least one embodiment, the remote user communicates to the communications engine via a point-to-point direct connection between the remote user's electronic device and the surveillance unit.

In at least one embodiment, the user interface is configured to enable the remote user to start the surveillance device, to set up one or more operating parameters of the surveillance device, and to stop the surveillance device.

In at least one embodiment, the vision processing engine comprises: a video processing engine configured to read a plurality of frames captured by the at least one visual sensor, an object detector configured to run an object detection algorithm to detect one or more objects and one or more features of the one or more objects, a filter and feature extractor configured to (i) extract the one or more features, (ii) filter the one or more features, thereby generating one or more filtered features, (iii) store the one or more features and/or one or more filtered features in a repository, and (iv) match the one or more features and/or the one or more filtered features to data stored in the repository, a tracker configured to monitor the one or more objects and to assign object identifiers to the one or more objects, a vehicle information detector configured to extract vehicle information from the one or more images, a license plate detector and reader configured to run the object detection algorithm to detect one or more portions of a vehicular license plate and to read the one or more portions, a Global Positioning System (GPS) engine configured to collect GPS location information from the one or more objects, and a decision engine configured to send alerts, generate reports, and generate annotated videos.

In at least one embodiment, the repository is configured to store the one or more filtered features in a searchable data structure.

In at least one embodiment, the one or more features is selected from the group consisting of: type of object, probability of a type of object, bounding box, and combinations thereof.

In at least one embodiment, the object detection algorithm is a You Only Look Once (YOLO) algorithm.

In at least one embodiment, the aforementioned assignment of object identifiers uses bounding box tracking and similarities of the one or more features.

In at least one embodiment, the aforementioned filtration of the one or more features uses Principal Component Analysis (PCA).

In at least one embodiment, the decision engine sends the alerts if the decision engine determines if an object in the one or more objects matches a target in a predetermined list of targets. The decision engine may further add objects with the assigned object identifiers to the generated reports. The annotated videos may additionally comprise license plate information merged into videos captured by the at least one visual sensor.

In at least one embodiment, the aforementioned extraction of the vehicle information comprises filtering the one or more images using one or more blur detection algorithms, and the vehicle information is selected from the group consisting of: vehicle make information, vehicle model information, vehicle color information, and combinations thereof.

In at least a further embodiment, a method for detection and/or surveillance is disclosed, the method comprising using a surveillance unit to: detect an object in an area, obtaining an object identifier for the object, identifying when the object is a vehicle, determining when the object is a target of interest, and, when the object is a vehicle, activating either an intelligence mode or a defensive mode of the surveillance unit.

In at least one embodiment, the method further comprises, in the intelligence mode: sending a first intelligence alert to a user of the surveillance unit when the vehicle is the target of interest, tracking the vehicle, generating a report on the vehicle's movements for the user, and sending a second intelligence alert to the user if the vehicle is out of frame of the surveillance unit for a predetermined period of time.

In at least one embodiment, the method further comprises, in the intelligence mode: gathering information on the area, wherein the information is selected from the group consisting of: a number of persons in the area, a number of vehicles in the area, a number of WiFi devices in the area, a number of WiFi networks in the area, license plates in the area.

In at least one embodiment, the method further comprises, in the defensive mode, tracking the vehicle, generating a report on the vehicle's movements for a user of the surveillance unit, determining whether the vehicle is seen again in the area, and sending a defensive alert to the user.

In at least one embodiment, the method further comprises, in the defensive mode, detecting when an individual is conducting surveillance in the area, tracking movement of the individual, and determining whether the individual is on foot or in a vehicle.

Therefore, based on the foregoing and continuing description, the subject invention in its various embodiments may comprise one or more of the following features in any non-mutually-exclusive combination:
A system for detection and/or surveillance comprising one or more surveillance units for surveilling an area;
Each of the one or more surveillance units comprising one or more visual sensors configured to obtain one or more images of a target in the area;
Each of the one or more surveillance units comprising one or more audio sensors configured to obtain audio of the area;
Each of the one or more surveillance units comprising one or more location sensors configured to obtain positional data regarding the target and/or the area;
Each of the one or more surveillance units comprising one or more network sensors and/or one or more antennas operably connected to one or more WiFi cards and/or one or more Bluetooth cards;
Each of the one or more surveillance units comprising one or more dongles configured to communicate with one or more external networks;
Each of the one or more surveillance units comprising one or more data storage devices; Each of the one or more surveillance units comprising one or more cooling units;
Each of the one or more surveillance units comprising one or more clocks and/or timers;
The target being selected from the group consisting of: a vehicle, a portion of a vehicle, a person, an animal, a ship or other watercraft, and combinations thereof;
The one or more images including information selected from the group consisting of: a vehicle's make, a vehicle's model, a vehicle's color, and a vehicle's license plate, and combinations thereof;
Each of the one or more surveillance units further comprising one or more movement sensors configured to detect movement of at least one of the one or more surveillance units;
Two or more surveillance units monitoring two different areas such that data gathered by any one of the surveillance units is transmitted to one or more of the other surveillance units;
Two or more surveillance units monitoring two different areas such that targets identified by any one of the surveillance units is transmitted to one or more of the other surveillance units;
Each of the one or more surveillance units further comprising at least one computer comprising at least one processor operatively connected to at least one non-transitory, computer readable medium, the at least one non-transitory computer readable medium having computer-executable instructions stored thereon, wherein, when executed by the at least one processor, the computer executable instructions carry out a set of steps;
The set of steps comprising performing surveillance on the target and/or the area over a predetermined period of time;
The set of steps comprising identifying the target and one or more properties of the target based on data gathered at a first point in time in the predetermined period of time;
The set of steps comprising identifying the target at a second point in time in the predetermined period of time based on the one or more properties;
The step of identifying the target and one or more properties of the target being performed using one or more artificial intelligence (AI) processes;
The target comprising a motorcycle rider;
The one or more properties of the target being selected from the group consisting of: a helmet, one or more portions of a motorcycle being ridden by the motorcycle rider, a wireless signature of an electronic device of the motorcycle rider, and combinations thereof;
The set of steps further comprising identifying the target at the second point in time by comparing (i) one or more image frames and/or features captured at the first point in time and one or more image frames and/or features captured at the second point in time with (ii) historical data stored on the one or more data storage devices;
The data gathered at the first point in time comprising the one or more images;
The one or more images including one or more portions of a vehicle other than the vehicle's license plate;
The target being a person surveilling at least one of the one or more surveillance units;
At least one of the one or more surveillance units being a surveillance device that is configured to operate without connection to a power grid;
The surveillance device being placed in a moving vehicle;
The area being surveilled by the device being an area behind the moving vehicle;
The target being a pursuing vehicle traveling in the area behind the moving vehicle and/or a person inside the pursing vehicle;
The one or more images including a license plate of the pursuing vehicle;
A surveillance device comprising at least one computer comprising at least one processor operatively connected to at least one non-transitory, computer readable medium, the at least one non-transitory computer readable medium having computer-executable instructions stored thereon, wherein, when executed by the at least one processor, the computer executable instructions carry out a set of steps;
The set of steps comprising observing, by at least one visual sensor comprised on the surveillance device, an area;
The set of steps comprising capturing, by the at least one visual sensor, one or more images of the area at a first point in time;
The set of steps comprising identifying, by the at least one processor, both a two-wheeled vehicle and one or more properties of the two-wheeled vehicle based on the one or more images;
The set of steps comprising identifying, by the at least one processor, the two-wheeled vehicle in the area at a second point in time based on the one or more properties;
The one or more properties not comprising a license plate of the two-wheeled vehicle;
The set of steps further comprising collecting, by one or more network sensors and/or one or more antennas operably connected to one or more WiFi and/or one or more Bluetooth cards comprised in the surveillance device, a WiFi identifier and/or a Bluetooth identifier from a person operating the two-wheeled vehicle;
The set of steps further comprising identifying, by the at least one processor, the person based on the WiFi identifier and/or the Bluetooth identifier;
The one or more properties comprising a combination of one or more features of the two-wheeled vehicle and one or more features of the person;
The computer executable instructions further defining a user interface engine configured to generate and display a user interface for the surveillance device;
The computer executable instructions further defining a communications engine configured to communicate with (i) the user interface engine, and (ii) a remote user of the surveillance device;
The computer executable instructions further defining a vision processing engine configured to capture one or more images from the at least one visual sensor;
The computer executable instructions further defining an audio processing engine configured to capture audio from at least one audio sensor comprised in the surveillance device;
The computer executable instructions further comprising a system manger configured to communicate with, and obtain data from, the vision processing engine and the audio processing engine;
The vision processing engine and the audio processing engine both being operably connected to one or more data repositories comprised in the surveillance device;
The surveillance device comprising one or more batteries that provide a sole source of power for the surveillance device;
The remote user being able to communicate with the communications engine via a point-to-point direct connection between the remote user's electronic device and the surveillance unit;
The user interface being configured to enable the remote user to start the surveillance device, to set up one or more operating parameters of the surveillance device, and to stop the surveillance device;
The vision processing engine further comprising a video processing engine configured to read a plurality of frames captured by the at least one visual sensor;
The vision processing engine further comprising an object detector configured to run an object detection algorithm to detect one or more objects and one or more features of the one or more objects;
The vision processing engine further comprising a filter and feature extractor configured to (i) extract the one or more features, (ii) filter the one or more features, thereby generating one or more filtered features, (iii) store the one or more features and/or one or more filtered features in a repository, and (iv) match the one or more features and/or the one or more filtered features to data stored in the repository;
The vision processing engine further comprising a tracker configured to monitor the one or more objects and to assign object identifiers to the one or more objects;
The vision processing engine further comprising a vehicle information detector configured to extract vehicle information from the one or more images;
The vision processing engine further comprising a license plate detector and reader configured to run the object detection algorithm to detect one or more portions of a vehicular license plate and to read the one or more portions;
The vision processing engine further comprising a Global Positioning System (GPS) engine configured to collect GPS location information from the one or more objects;
The vision processing engine further comprising a decision engine configured to send alerts, generate reports, and generate annotated videos;
The repository being configured to store the one or more filtered features in a searchable data structure;
The one or more features being selected from the group consisting of: type of object, probability of a type of object, bounding box, and combinations thereof;
The object detection algorithm being a You Only Look Once (YOLO) algorithm; The assignment of object identifiers using bounding box tracking and similarities of the one or more features;
The filtration of the one or more features using Principal Component Analysis (PCA);
The decision engine being configured to send the alerts if the decision engine determines if an object in the one or more objects matches a target in a predetermined list of targets;
The decision engine being configured to add objects with the assigned object identifiers to the generated reports;
The annotated videos generated by the decision engine comprising license plate information merged into videos captured by the at least one visual sensor;
The extraction of the vehicle information comprising filtering the one or more images using one or more blur detection algorithms;
The vehicle information being selected from the group consisting of: vehicle make information, vehicle model information, vehicle color information, and combinations thereof;
A method for detection and/or surveillance comprising using a surveillance unit;
Using the surveillance unit to detect an object in an area;
Using the surveillance unit to obtain an object identifier for the object;
Using the surveillance unit to identify when the object is a vehicle;
Using the surveillance unit to determine when the object is a target of interest;
When the object is a vehicle, using the surveillance unit to activate either an intelligence mode or a defensive mode of the surveillance unit;
Using the surveillance unit, in the intelligence mode, to send a first intelligence alert to a user of the surveillance unit when the vehicle is the target of interest;
Using the surveillance unit, in the intelligence mode, to track the vehicle;

Using the surveillance unit, in the intelligence mode, to generate a report on the vehicle's movements for the user;
Using the surveillance unit, in the intelligence mode, to send a second intelligence alert to the user if the vehicle is out of frame of the surveillance unit for a predetermined period of time;

Using the surveillance unit, in the intelligence mode, to gather information on the area;
The aforementioned information being selected from the group consisting of: a number of persons in the area, a number of vehicles in the area, a number of WiFi devices in the area, a number of WiFi networks in the area, license plates in the area, and combinations thereof;
Using the surveillance unit, in the defensive mode, to track the vehicle;
Using the surveillance unit, in the defensive mode, to generate a report on the vehicle's movements for a user of the surveillance unit;
Using the surveillance unit, in the defensive mode, to determine whether the vehicle is seen again in the area;
Using the surveillance unit, in the defensive mode, to send a defensive alert to the user;
Using the surveillance unit, in the defensive mode, to detect when an individual is conducting surveillance in the area;
Using the surveillance unit, in the defensive mode, to track movement of the individual;
Using the surveillance unit, in the defensive mode, to determine whether the individual is on foot or in a vehicle;
A method for detection and/or surveillance comprising using any of the surveillance devices, surveillance units, and/or surveillance systems described above.

These and further and other objects and features of the invention are apparent in the disclosure, which includes the above and ongoing written specification, as well as the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 illustrates a block diagram of a surveillance system, according to at least one embodiment of the present disclosure.

FIG. 2 illustrates a block diagram of surveillance system software, according to at least one embodiment of the present disclosure.

FIG. 3 is a flow chart diagram of the vision processing engine shown in FIG. 2, according to at least one embodiment of the present disclosure.

FIG. 4 is a flow chart of a method of surveillance, according to at least one embodiment of the present disclosure.

FIG. 5 illustrates a product of manufacture, according to at least one embodiment of the present disclosure.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms first, second, etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, “at least one of A, B, and C” indicates A or B or C or any combination thereof. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two FIGS. shown in succession may in fact be executed substantially concurrently or may sometimes be executed in the reverse order, depending upon the functionality and/or acts described or depicted.

Ranges are used herein shorthand so as to avoid having to list and describe each and every value within the range. Any appropriate value within the range can be selected, where appropriate, as the upper value, lower value, or the terminus of the range.

Unless indicated to the contrary, numerical parameters set forth herein are approximations that can vary depending upon the desired properties sought to be obtained. At the very least, and not as an attempt to limit the application of the doctrine of equivalents to the scope of any claims, each numerical parameter should be construed in light of the number of significant digits and ordinary rounding approaches.

The words “comprise”, “comprises”, and “comprising” are to be interpreted inclusively rather than exclusively. Likewise the terms “include”, “including” and “or” should all be construed to be inclusive, unless such a construction is clearly prohibited from the context. The terms “comprising” or “including” are intended to include embodiments encompassed by the terms “consisting essentially of” and “consisting of”. Similarly, the term “consisting essentially of” is intended to include embodiments encompassed by the term “consisting of”. Although having distinct meanings, the terms “comprising”, “having”, “containing’ and “consisting of” may be replaced with one another throughout the description of the invention.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

“Typically” or “optionally” means that the subsequently described event or circumstance may or may not occur, and that the description includes instances where said event or circumstance occurs and instances where it does not.

Wherever the phrase “for example,” “such as,” “including” and the like are used herein, the phrase “and without limitation” is understood to follow unless explicitly stated otherwise.

As used herein, the terms “plurality” and “a plurality” include, for example, “multiple” or “two or more.” For example, “a plurality of items” includes two or more items.

In general, the word “instructions,” as used herein, refers to logic embodied in hardware or firmware, or to a collection of software units, possibly having entry and exit points, written in a programming language, such as, but not limited to, Python, R, Rust, Go, SWIFT, Objective C, Java, JavaScript, Lua, C, C++, or C#. A software unit may be compiled and linked into an executable program, installed in a dynamic link library, or may be written in an interpreted programming language such as, but not limited to, Python, R, Ruby, JavaScript, or Perl. It will be appreciated that software units may be callable from other units or from themselves, and/or may be invoked in response to detected events or interrupts. Software units configured for execution on computing devices by their hardware processor(s) may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. Generally, the instructions described herein refer to logical modules that may be combined with other modules or divided into sub-modules despite their physical organization or storage. As used herein, the term “computer” is used in accordance with the full breadth of the term as understood by persons of ordinary skill in the art and includes, without limitation, desktop computers, laptop computers, tablets, servers, mainframe computers, smartphones, handheld computing devices, and the like.

In this disclosure, references are made to users performing certain steps or carrying out certain actions with their client computing devices/platforms. In general, such users and their computing devices are conceptually interchangeable. Therefore, it is to be understood that where an action is shown or described as being performed by a user, in various implementations and/or circumstances the action may be performed entirely by the user's computing device or by the user, using their computing device to a greater or lesser extent (e.g. a user may type out a response or input an action, or may choose from preselected responses or actions generated by the computing device). Similarly, where an action is shown or described as being carried out by a computing device, the action may be performed autonomously by that computing device or with more or less user input, in various circumstances and implementations.

In this disclosure, various implementations of a computer system architecture are possible, including, for instance, thin client (computing device for display and data entry) with fat server (cloud for app software, processing, and database), fat client (app software, processing, and display) with thin server (database), edge-fog-cloud computing, and other possible architectural implementations known in the art.

As used herein, terms such as, for example, “processing,” “computing,” “calculating,” “determining,” “establishing,” “analyzing,” “checking,” or the like, may refer to one or more operations and/or processes of a computer, a computing platform, a computing system, or other electronic computing devices, that manipulate and/or transform data represented as physical (e.g., electronic) quantities with in the computer's registers and/or memories into other data similarly represented as physical quantities within the computer's registers and/or memories or other information storage medium that may store instructions to perform operations and/or processes.

The term “circuitry” as used herein may refer to, be a part of, or include, an Application Specific Integrated Circuit (ASIC), an integrated circuit, an electronic circuit, a processor (e.g., shared, dedicated, or group), and/or memory (e.g., shared, dedicated, or group), that execute one or more software or firmware programs, a combinational logic circuit, and/or other suitable hardware components that provide the described functionality. In some demonstrative embodiments, the circuitry may be implemented in, or functions associated with the circuitry may be implemented by, one or more software or firmware modules. In some demonstrative embodiments, the circuitry may include logic, at least partially operable in hardware.

The term “logic” as used herein may refer to, for example, computing logic embedded in the circuitry of a computing apparatus and/or computing logic stored in a memory of a computing apparatus. As a non-limiting example, the logic may be accessible by a processor of the computing apparatus to execute the computing logic to perform computing functions and/or operations. In a further example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, or the like. In one example, logic may be embedded in volatile memory and/or non-volatile memory, including random access memory, read-only memory, programmable memory, magnetic memory, flash memory, persistent memory, and the like. Logic may be executed by one or more processors using memory (e.g., registers, stuck, buffers, or the like) coupled to the one or more processors as necessary to execute the logic.

The term “module” as used herein may refer to an object file that contains code to extend the running kernel environment.

The term “artificial intelligence (AI)” as used herein may refer to intelligence demonstrated by machines, which is unlike the natural intelligence involving consciousness and emotionality that is displayed by humans and animals. Thus, the term “artificial intelligence” can be used to describe machines (e.g., computers) that mimic “cognitive” functions that humans associate with the human mind, such as, for example, “learning” and “problem-solving.”

The term “machine learning (ML)” as used herein may refer to a study of computer algorithms configured to automatically improve based on received data. It should be appreciated that ML is a subset of artificial intelligence. Additionally, machine learning algorithms build a mathematical model based on sample data, known as “training data,” to make predictions or decisions without being explicitly programmed to do so.

The term “deep learning” as used herein may refer to a class of machine learning algorithms that uses multiple layers to extract higher-level features from raw inputs in a progressive fashion. As a non-limiting example, in image processing, lower layers may identify edges, while higher layers may identify the concepts relevant to a human, such as, for example, digits, letters, and/or faces.

The terms “artificial neural networks (ANNs)” and “neural networks (NNs)” as used herein may refer to computing systems inspired and/or based on biological neural networks that constitute human or animal brains, or portions thereof. As a non-limiting example, an ANN can be based on a collection of connected units or nodes called “artificial neurons,” which loosely model the neurons in a biological brain. An artificial neuron that receives a signal may process it and may signal one or more other neurons connected to it. For instance, the “signal” at a specific connection may be a real number, and the output of each neuron is computed by some non-linear function of the sum of its inputs. The connections may be called “edges” and both neurons and edges may have a weight that adjusts as learning proceeds. The weight can increase or decrease the strength of the signal at a given connection. Neurons may also have a threshold such that a signal is sent only if the aggregate signal crosses that threshold. The neurons may further be aggregated into layers, and different layers may perform different transformations on their respective inputs.

The term “YOLO (You Only Look Once)” as used herein may refer to an object detection algorithm. In YOLO, a single convolutional network predicts both the bounding boxes and the class probabilities for these boxes. In general, YOLO works on an image and splits it into a grid. Within the grid, YOLO takes a certain number of bounding boxes. For each of these bounding boxes, the network outputs a class probability and offset values. The bounding boxes that have a class probability above a specific threshold value are selected and used to locate an object within an image.

The term “residual neural network (ResNet)” as used herein may refer to an ANN of a kind that builds on constructs known from pyramidal cells in the cerebral cortex. ResNet networks may achieve this by utilizing skip connections and/or shortcuts to jump over one or more layers. ResNet models may further be implemented with double- or triple-layer skips that contain nonlinearities (ReLU) and batch normalization in-between.

Generally, the present disclosure is directed to systems, apparatuses, devices, and methods for surveillance. In at least some embodiments, a surveillance unit (a term which, as used herein, includes, for example, a surveillance device, apparatus, and/or system) is disclosed that is configured to function as a stand-alone detection and/or surveillance unit; that is, it functions without a network or external power. As a non-limiting example, the surveillance unit may use different stand-alone power sources such as, for example, batteries, renewable energy sources, and the like.

In at least one embodiment, the aforementioned batteries may include, for instance, lithium-based batteries, zinc-based batteries, nickel-based batteries, chargeable batteries, and the like.

In at least another embodiment, the surveillance unit is configured to detect and/or surveil vehicles, including vehicles without license plates (e.g., motorcycles or motorbikes without license plates displayed in the front of the motorcycle or motorbike, respectively).

In at least a further embodiment, the surveillance unit is configured to save and/or store one or more images of one or more detected and/or surveilled vehicles (e.g., a specific motorcycle or motorbike) at selected frames over time and compare the one or more images to one or more previously-taken images for similarity.

In at least an additional embodiment, the surveillance unit is configured to combine information from visual and network sensors to detect surveillance. For example, the system may identify a vehicle with license plate X and a mobile device with WiFi with unique identifier Y. Then, after a predetermined time, e.g., as set by the user, the system may identify the same vehicle, for example, having the same and/or similar license plate and a different mobile device. The surveillance unit and/or device and/or system may deduct using an algorithm and/or AI that, for example, the object under surveillance has switched mobile devices. It should be understood that other deductions can be made.

In at least an additional embodiment, the surveillance unit is configured to be left in, and to operate in, one or more locations to monitor and/or surveil the area around the one or more locations “in the field” (a term which, as used herein, refers to one or more outdoor areas or natural environments in which the surveillance unit need not be connected to, or communicate with, any devices or systems located in a laboratory, office, police headquarters, or the like).

In at least an additional embodiment, the surveillance unit comprises one or more motion detectors. As a non-limiting example, the motion detector may be configured to detect movement of the surveillance unit itself, and, when such movement is detected, the surveillance unit is configured to “wipe” the unit (e.g., to delete all information captured during one or more periods of detection and/or surveillance). This may be done to prevent information leakage where, for instance, the surveillance unit is being stolen or taken.

In at least an additional embodiment, the surveillance unit is configured for data security such that all communications between a user and the unit is performed via peer-to-peer and/or secure connections (e.g., encrypted connections), rather than through open messaging systems, unprotected cloud-based systems, and the like.

In at least an additional embodiment, the surveillance unit is configured to operate in at least two modes, specifically an intelligence mode and a defensive mode.

In at least one embodiment, if the surveillance unit is in the intelligence mode, the unit is configured to gather information on one or more targets (e.g., vehicles, motorcycles, motorbikes, people, WiFi devices, WiFi networks, animals, and the like) to map an area around the unit. This may be done before a surveillance or monitoring operation and/or to track a specific target that is known or suspected to be in the area. For instance, the surveillance unit may try to match a target to known lists (e.g., a “target” list for further detection and/or surveillance, a “white” list for targets that may be ignored, etc.). As another example, if a police agency or organization decides to detect stolen cars (e.g., on a road or highway), the unit may be placed in a police vehicle or any other vehicle to perform surveillance in an area near or around the road, which may include, for instance, an urban area.

In at least another embodiment, if the surveillance unit is in the defensive mode, the unit is configured to detect one or more targets that are either static or moving. For instance, the unit may attempt to match objects seen before without knowing any identifiers of the objects. In at least one example, the one or more targets may be, for instance, an individual conducting surveillance in the area that the surveillance unit is monitoring or viewing. The unit may be configured to detect an individual on foot (via, e.g., the WiFi connection on the individual's mobile device), on a motorcycle or motorbike, in a vehicle, etc. As a further example, the unit may be situated next to a building (e.g., school) to detect one or more vehicles that may be moving or patrolling near the school in anticipation of a malicious attack. As yet another example, the unit may be positioned in the rear of a vehicle (e.g., a VIP (very important person) vehicle) to determine if one or more individuals is following the vehicle. If so, the unit may be configured to send an alert, in real-time or near real-time, to one or more users (e.g., security agencies, security forces, police agencies, anti-terrorism agencies, and the like).

It should be appreciated that, in at least some embodiments described herein, all processing of data and/or information collected by the surveillance unit is done within the unit. That is, none of the data and/or information is sent to another device or system. Thus, the surveillance unit can function as a stand-alone entity without the need for external connections (e.g., external power connections).

In at least an additional embodiment, the surveillance unit is powered by an external power supply that need not be connected to a power grid (e.g., one or more batteries, such as a car battery), and is configured to transmit alerts and/or be fully accessed via one or more networks (e.g., WiFi, cellular system networks, local area networks (LAN), wide area network (WAN), wireless local area networks (WLAN), wireless wide area networks (WWAN), and the like).

In at least a further embodiment, the surveillance unit is configured to collect and analyze one or more signals (e.g., visual signals, network signals, network transactions, audio signals, and the like) in real-time or near real-time in the field. A user may then collect the surveillance unit from its field location and use the analyzed report of the processed data, as opposed to collecting raw data (e.g., videos) and having to perform processing himself or herself.

In at least a further embodiment, the surveillance unit is configured such that the unit can be left in a field location and enable connection to the unit via a secure connection. A user can therefore access the surveillance unit remotely and view any processed information in real-time or near real-time.

In a non-limiting example, the surveillance unit is mobile and, advantageously, can be set in a moving vehicle and perform detection and/or surveillance at speeds up to 130 kilometers per hour. The surveillance unit can also be configured to analyze, using one or more information sources), if an individual in an area is conducting their own surveillance. The surveillance unit may achieve this by analyzing, in real-time or near real-time, the information sources and determining if similar objects (e.g., vehicles with similar license plates, riders of motorcycles or motorbikes that are familiar to previously-seen riders, mobile devices that have the same identifier) are “seen” or sensed within a given time frame and/or distance from the surveillance unit. If so, the surveillance unit may be configured to send one or more alerts to a user of the surveillance unit.

Further, such a user of the surveillance unit can establish one or more rules governing detection and/or surveillance. One such rule may state: “provide an alert if a vehicle with the same license plate, up to a one digit difference, is seen in specific predetermined locations, where the first location is X kilometers from a second location, and Y minutes has passed between the first location of the vehicle and the second location of the vehicle.”

Advantageously, since embodiments of the surveillance unit are mobile, it can be set up in the rear of a moving vehicle (e.g., facing backwards), as well as in a fixed position (e.g., in front of a building or residence).

Additionally, at least one embodiment of the surveillance unit is configured to make autonomous tactical intelligence gathering usable in the field. The surveillance unit may therefore be used by law enforcement agencies, private security companies, and the like. The unit can be used when it is difficult to locate a specific individual in the field (e.g., due to a security risk, high cost, technical issues, and the like) and/or when communication of high-resolution video or images to a control center or headquarters is inefficient, ineffective, or impossible (e.g., due to technical limitations, financial limitations, risk of detection, and the like).

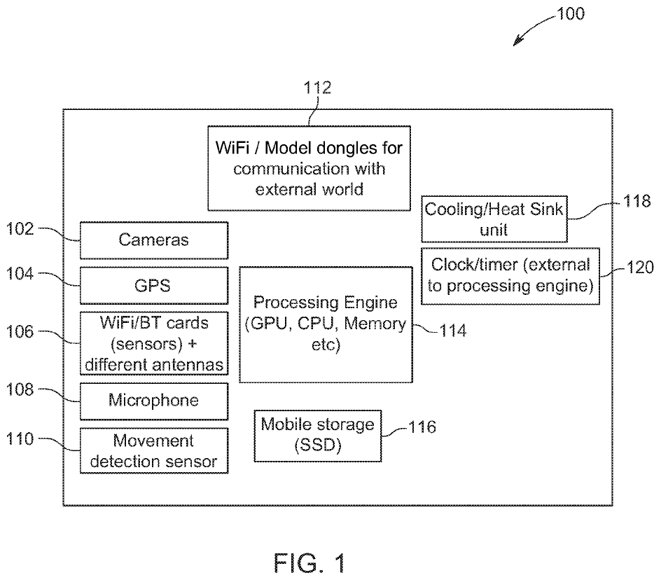

Turning now to FIG. 1, a block diagram is shown of a surveillance unit 100, according to at least one embodiment of the present disclosure. The surveillance unit 100 comprises one or more visual sensors (such as cameras 102), one or more location sensors (such as GPS sensor 104), one or more network sensors and/or one or more antennas 106 operably connected to, for example, WiFi and/or Bluetooth cards, one or more audio sensors (such as microphone 108), and/or one or more movement detection sensors 110. The surveillance unit 100 further comprises one or more WiFi and/or cellular dongles 112 configured to communicate with one or more external networks, at least one computer comprising at least one processor 114, and one or more types of mobile storage (e.g., solid-state drive (SSD) 116). The surveillance unit 100 additionally comprises a cooling unit (e.g., heat sink 118), and a clock or timer 120. The clock or timer may be external to the at least one computer processor 114.

In at least one embodiment, the surveillance unit is configured to gather tactical intelligence from one or more information sources and/or supply wide tactical intelligence data and/or detect surveillance.

In at least another embodiment, the surveillance unit may comprise at least one computer comprising at least one processor operatively connected to at least one non-transitory, computer readable medium, the at least one non-transitory computer readable medium having computer-executable instructions stored thereon, wherein, when executed by the at least one processor, the computer executable instructions carry out a set of steps. The at least one processor may include, for instance, a plurality of processor cores (e.g., up to ten processor cores), an AI model, a graphic processor, a memory, and the like.

In at least a further embodiment, one or more surveillance units may be operably coupled to at least one computer processor (e.g., processor 114) via an interface (not shown). The interface may be configured to convert data and/or information (e.g., images) received from the one or more units to data that can be processed by the at least one computer processor, and vice versa.

In at least an additional embodiment, the surveillance unit comprises one or more visual sensors (e.g., cameras such as cameras 102, camcorders, video recorders, and the like). The unit may be configured to capture images of vehicles (e.g., four-wheeled vehicles such as cars, trucks, or vans, two-wheeled vehicles such as bicycles and motorcycles, etc.). Images may also be captured of one or more portions or aspects of the vehicles (e.g., vehicle make, vehicle model, vehicle color, license plate, and the like).

In at least an additional embodiment, the one or more visual sensors may be configured to capture images of targets other than vehicles (e.g., people, animals, airplanes, boats, containers, etc.).

In at least an additional embodiment, the surveillance unit may comprise one or more location sensors (e.g., global positioning system (GPS) sensors 104) configured to collect positional data.

In at least an additional embodiment, the surveillance unit may comprise one or more network sensors and/or one or more antennas operably connected to, for example, WiFi and/or Bluetooth cards. For example, the WiFi and/or Bluetooth card and/or a cellular card can be configured to collect information about a mobile device, access points, routers, and the like.

In at least an additional embodiment, the surveillance unit may comprise one or more WiFi and/or Bluetooth cards. For instance, a WiFi dongle and/or cellular dongle can be configured to communicate with one or more external networks.

In at least an additional embodiment, the surveillance unit may comprise one or more types of mobile storage (e.g., SSD 116) to store any data and/or information collected by the surveillance unit.

In at least an additional embodiment, the surveillance unit may comprise one or more audio sensors, such as, for example, a microphone (such as microphone 108) configured to collect audio information (e.g., record audio conversations or surrounding voices).

In at least an additional embodiment, the surveillance unit may comprise one or more movement detectors (such as movement sensor 110) configured to detect one or more movements (e.g., unauthorized movements of the surveillance unit. If desired, the unit itself may be configured to erase all gathered data if such one or more movements are detected.

It should be appreciated that the surveillance unit need not have at least one of each sensor type described herein. For instance, the surveillance unit can perform one or more of the methods described herein using only a visual sensor and a WiFi sensor, without any of the other sensor types (e.g., audio sensor).

In at least an additional embodiment, the surveillance unit may comprise one or more of the following: a clock and/or a timer 120, a cooling unit and/or a heat sink such as heat sink 118, and a battery).

In at least an additional embodiment, the surveillance unit is configured to share and/or transfer information observed and/or captured between different portions or aspects of the unit (e.g., the one or more visual sensors, the WiFi cards, and/or the Bluetooth cards). For instance, if the surveillance unit obtains the Bluetooth identifier from a device being carried from a person of interest, the unit can save that information and relay and/or connect the information to the WiFi identifier and/or license plate identifier. In such a fashion, the surveillance unit can connect Bluetooth identifier information to WiFi connection information obtained from the person's device and/or a license plate on a vehicle the person may be in.

In at least an additional embodiment, two or more surveillance units can be used to monitor and/or surveil one or more locations, and gathered data can be shared between the two or more surveillance units. As a non-limiting example, two surveillance units (unit A and unit B) are monitoring areas A and B, respectively. The distance between units A and B can be any distance (e.g., up to 5 kilometers apart). All data gathered by surveillance unit A is transmitted to surveillance unit B, and vice versa. For instance, surveillance unit A surveying area A can identify a target (e.g., a vehicle with an unknown license plate or no displayed license plate) and transmit the gathered data on the target, as well as any identifying features of the target (e.g., vehicle make and model, vehicle color), to surveillance unit B that is surveying area B. If the vehicle then enters area B, surveillance unit B can identify the target and track the target. This can be done without knowing the vehicle's license plate. Accordingly, two or more surveillance units can be used together to identify and track, for instance, a vehicle that has visited two different gas stations, located in two different places, within a certain period of time (e.g., one hour

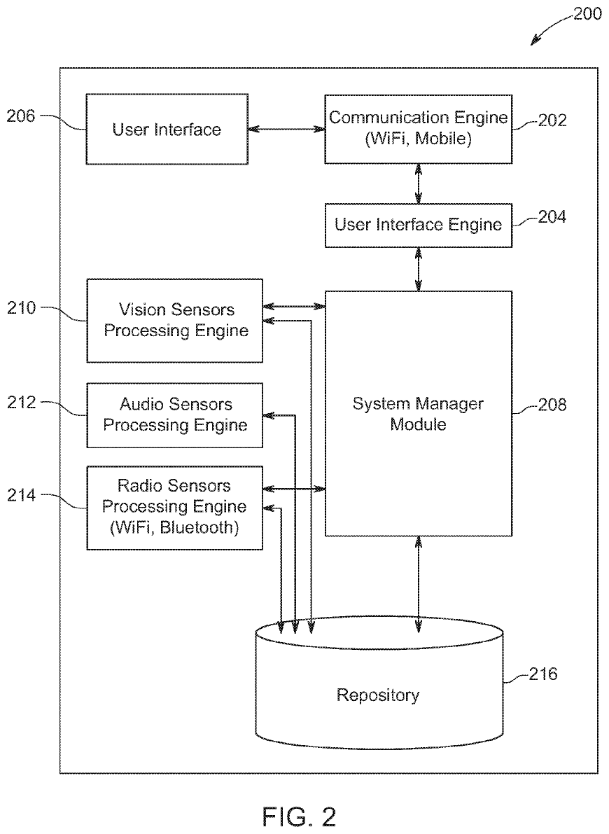

Turning now to FIG. 2, a block diagram is shown of surveillance unit software 200, according to at least one embodiment of the present disclosure. The surveillance unit software 200 comprises a communications engine 202 that communicates with, and/or is operably connected to, both a user interface engine 204 and a user interface 206. The user interface engine 204 is configured to communicate with, and/or is operably connected to, a system manager module 208. The system manager module is configured to communicate with, and/or is operably connected to, the following: a vision sensors processing engine 210, an audio sensors processing engine 212, a radio sensors processing engine 214, and a repository 216 for data storage. The individual processing engines 210, 212, and 214 are also each configured to communicate with, and/or are operably connected to, the repository 216.

In at least one embodiment, the surveillance unit may be placed in a selected location to surveil one or more targets and/or detect one or more individuals conducting their own surveillance. Additionally, a user of the surveillance unit may communicate with, and/or control, the surveillance unit via a communications engine (such as communications engine 202) configured to process data received from, for example, a WiFi dongle.

In at least another embodiment, the user may interact with the surveillance unit using one or more user electronic devices (e.g., a mobile device, a smartphone, a tablet, a desktop computer, a laptop, and the like). The user may perform one or more functions using the one or more user electronic devices (e.g., set up camera position of the surveillance unit, connect or disconnect portions of the surveillance unit (such as cameras or GPS sensors), start and/or stop operations of the surveillance unit, and the like).

In at least a further embodiment, the communications engine (such as communications engine 202) can be configured to enable the user to communicate with the surveillance unit using, for instance, either a WiFi or cellular connection. The connection handshake may be done via a server, but the actual communication (data transfer) may be done via a Point to Point (PTP) connection, e.g., direct connection, between the user electronic device and the surveillance unit.

In at least an additional embodiment, a user interface engine (such as user interface engine 204) may be configured to convert data received from the communications engine into data that can be used by a system manager (such as system manager module 208). For example, the user interface engine may manage the user interface (such as user interface 206) and enable the user to control the surveillance unit, set up operating parameters, start and stop the surveillance unit, and the like.

In at least an additional embodiment, a system manager (such as system manager module 208) is configured to manage one or more processors or engines, for example, the user interface engine, one or more engines controlling the vision sensors (such as vision sensors processing engine 210), one or more engines controlling the audio sensors (such as audio sensors processing engine 212), one or more engines controlling the movement detectors, one or more engines controlling the radio sensors (such as radio sensors processing engine 214), and the like. Furthermore, the system manager may also manage timers, security of the surveillance unit (e.g., ability to wipe the surveillance unit, encryption, etc.), storage, memory management, location management, and the like.

In at least an additional embodiment, data received from, for example, the system manager, the user interface engine, the one or more engines controlling the vision sensors, the one or more engines controlling the audio sensors, and/or the one or more engines controlling the movement detectors may be sent to, and stored on, one or more storage devices (e.g., SSD).

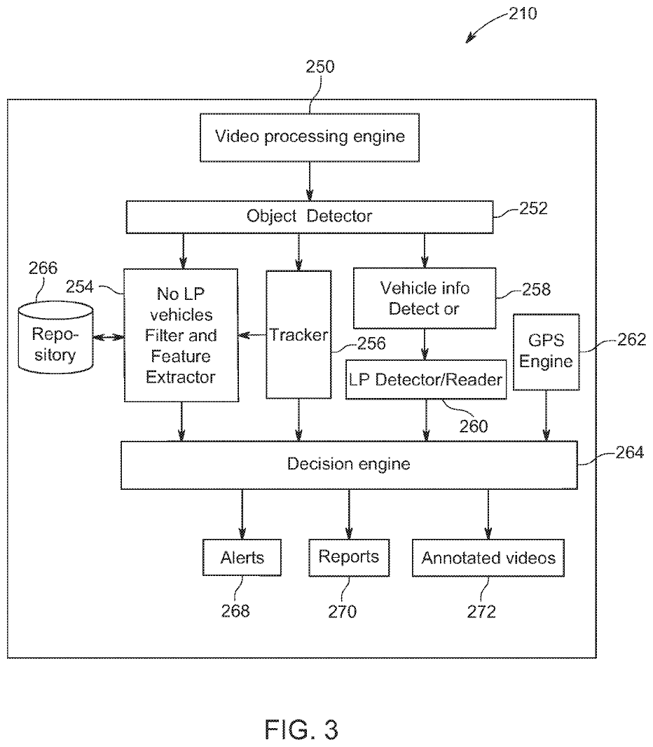

Turning now to FIG. 3, a flow chart diagram is shown of the vision processing engine 210 previously shown in FIG. 2. The vision processing engine 210 can comprise at least the following: a video processing engine 250, an object detector 252, a filter and feature extractor 254, a tracker 256, a vehicle information detector 258, a license plate detector/reader 260, a GPS engine 262, a decision engine 264, and a repository 266. The decision engine can be configured to send alerts 268, generate reports 270, and generate annotate videos 272.

In at least one embodiment, the vision processing engine may comprise a video processing engine (such as video processing engine 250) configured to read frames from the one or more visual sensors (e.g., camera).

In at least another embodiment, the vision processing engine may comprise an object detector (such as object detector 252) configured to run an object detection algorithm (e.g., YOLO) to detect one or more objects and one or more features of these objects (e.g., type of object, bounding box, probability, etc.).

In at least a further embodiment, the vision processing engine may comprise a vehicle information detector (such as vehicle information detector 258) configured to run, for example, one or more ResNet detectors to find, e.g., the make, model, and/or color of a given vehicle.

In at least an additional embodiment, the vision processing engine may comprise a GPS engine (such as GPS engine 262) configured to collect GPS information and to feed the GPS information into the surveillance unit.

In at least an additional embodiment, the vision processing engine may comprise a License Plate (LP) detector or reader (such as LP detector/reader 260) configured to use an object detection algorithm (e.g., YOLO) to detect an area of a license plate and then to read the digits of the license plate.

In at least an additional embodiment, the vision processing engine may comprise a tracker (such as tracker 256) configured to monitor and assign detected objects present in different frames to a single “object id” (that is, the same instance of an object). A skilled artisan will appreciate that such assignment may use one or more methods, e.g., bounding box tracking (using Intersection over Union (IOU) values or thresholds) and the similarity of extracted features (using, for example, ResNet without the fully connected layers to extract features).

In at least an additional embodiment, the vision processing engine may comprise a “No LP” vehicles filter and feature extractor (such as filter and feature extractor 254) configured to extract features using, for example, ResNet (e.g., without fully connected layers), to filter and reduce features using, for example, Principal Component Analysis (PCA), to store features per object/frame in a repository (such as repository 266), and to match the object to one or more previous objects from one or more previous frames found in the repository. This is done when a match based on a similar license plate cannot be made; for instance, because there is no license plate (e.g., motorcycles or vehicles in places that do not mandate display of a front license plate).

In at least an additional embodiment, the vision processing engine may comprise a repository (such as repository 266) configured to store reduced feature vectors of one or more objects in an efficient and searchable data structure (e.g., Hierarchical Navigable Small Worlds (HS NW)).

In at least an additional embodiment, the vision processing engine may comprise a decision engine (such as decision engine 264) configured to decide, in an intelligence mode, if an object matches rules for an alert based on a list of targets and, in defensive mode, use time and distance difference definitions. If a match is found, the engine may send one or more alerts, such as alerts 268 (e.g., using electronic mail (e-mail), text message, or Short Message Service (SMS)). The engine can also be responsible for writing every identified object to a report (such as reports 270) that a user can later access, as well as to save any videos taken by the one or more visual sensors (e.g., camera) with annotations of the objects merged into the video (such as annotated videos 272). Additional information can also be annotated, such as, for instance, tracker identification tags or numbers, license plates, and the like.

In at least an additional embodiment, the video processing engine may be configured to process frames of video captured by, for example, a video camera. For instance, a video frame of the captured video may be analyzed for object detection (e.g., a detected bounding box of vehicles, persons, motorcycles, and the like using a deep learning engine). The deep learning engine may use, for example, YOLO networks for object detection.

In at least an additional embodiment, an object detector (such as object detector 252) may detect objects using a deep learning engine. For instance, the deep learning engine may use one or more YOLO networks for object detection. The object detector may detect one or more objects (e.g., motorcycles) on, for example, filtered images of such motorcycles and matching them to previous frames and/or objects.

In at least an additional embodiment, the aforementioned vehicle information detector (such as vehicle information detector 258) may extract vehicle information from one or more images using deep learning methods (e.g., one or more ResNet networks). For example, motorcycle images may be filtered using various algorithms, including, for instance, a combination of “classic” image processing and deep learning methods, to remove unwanted images. Non-limiting examples of such unwanted images include images with bad height and/or weight proportions, images that are blurry or lack the requisite quality, images with contrast issues, and the like.

As a further example, image filter algorithms such as a blur detection algorithm may be used. Such blur detection algorithms include, but are not limited to, Laplacian variance, contrast algorithms (which include algorithms that reduce Gaussian blur), edge detection, and contour detection.

In at least an additional embodiment, the aforementioned LP detector or reader (such as LP detector/reader 260) may use one or more deep learning algorithms for feature extraction on a filtered image in order to read a license plate. Another algorithm may be used for feature reduction on a features vector to generate a reduced features vector that can be saved on the surveillance unit.

For example, the “No LP” vehicles filter and feature extractor 254 may use ResNet without the fully connected layers to receive a full features vector and may then use PCA to reduce dimensionality. Frames from the feature vector may be filtered based on the results from, for example, YOLO of the class threshold (e.g., objects that are not clearly identified as a biker with a bicycle may be deleted).

As a further example, the “No LP” vehicles filter and feature extractor 254 may keep an entire set of the reduced feature vectors per object (e.g., motorcycle) until the object is considered to have left the scene based on various time points where it is not seen in the video. Then, the set of the reduced feature vectors is compared against one or more previous sets of the reduced feature vectors, which have been saved from current videos and/or optionally from previous videos (e.g., so that a user can detect surveillance from previous days). This comparison may be done, for instance, using similarity between the reduced feature vectors. If matches are found (e.g., based on a threshold for amount, a time between matches, etc.), then the object is considered the same object (e.g., motorcycle) and it is passed to a detection surveillance engine not shown) to compare a time and/or distance interval.

As an additional example, one or more vectors may be stored in memory within a “mission” category in the surveillance unit, and can further be saved to, and loaded from, a repository or data storage (e.g., SSD). This permits a user to continue working on a continuous dataset between missions.

As an additional example, a “mission” may be categorized as a period of time when the surveillance unit is recording. For instance, the surveillance unit may record surveillance data (e.g., video) for three hours on the first day, save the data, and start to record on a second day at the same point in time as the end of the first day.

In at least an additional embodiment, the features may be collected from the ResNet (deep learning) network, then reduced using PCA, and then saved on the surveillance unit.

In at least an additional embodiment, a compression algorithm is configured to compare each vector from each frame of the same object A to each vector from each frame of an object B. Comparison may be done using, for instance, the cosine angle between feature vectors. If there are more than X pairs of vectors, of more than Y similarity, then there is a match.

In at least an additional embodiment, the set of the reduced feature vectors is inserted into a data structure that permits rapid searching. The data structure may also permit loading and/or saving from a repository (e.g., SSD) to keep its state across different videos and/or different days of surveillance operations.

In at least an additional embodiment, the aforementioned decision engine (such as decision engine 264) may generate a decision that is related to an observed target based on a feature vector, data from the tracker (such as tracker 256), and location of the target based on the aforementioned GPS engine. The decision engine may also generate and send alerts, reports, annotated videos, and the like to the user.

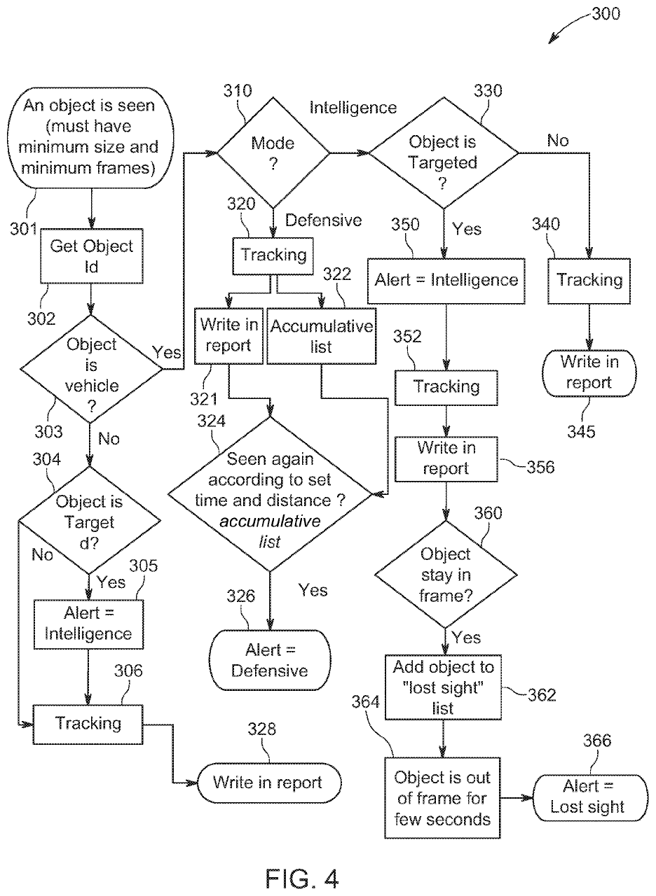

Turning now to FIG. 4, a flow chart of a method of surveillance is shown. The method uses a deep learning algorithm, according to at least one embodiment of the present disclosure.

The method shown starts with detecting an object at text box 301. Next, an object identification (ID) is obtained by the surveillance unit at text box 302. The unit can then identify if the object is a vehicle or a non-vehicular object (e.g., a person, an animal, etc.) at diamond 303. If the object is not a vehicle and not targeted (diamond 304), then the object can be tracked at text box 306. Then, a report may be generated regarding that tracked object at text box 328.

The aforementioned report may include, for example, an object ID, a time of detection, an object type, and one or more features of the object (e.g., images of the object, video of the object, and the like).

In at least one embodiment, if the object is targeted (diamond 304), an alert can be sent at text box 305 and/or an intelligence mode tracking can be initiated at text box 306. Additionally, as mentioned previously herein, a report can be issued at text box 328.

In at least another embodiment, the aforementioned intelligence mode can include, for instance, gathering information on one or more objects and/or targets (e.g., vehicles, motorcycles, people, WiFi devices, WiFi networks, animals, and the like) to map an area before an operation and/or to track a specific object and/or target. For example, the information gathered may include a number of persons and/or a number of vehicles on a given street at a given time. The information may further include, for instance, detecting when a given person or suspect with a known license plate is entering his or her garage and/or when he or she is leaving a specific location.

In a further example, intelligence mode further allows detecting information on stolen cars in an urban area, thereby enabling police agencies to set up operations and/or an ambush to apprehend one or more suspects.

In at least an additional embodiment, if the object is a vehicle (diamond 303), the surveillance unit may operate in different modes (diamond 310), such as defensive mode.

For instance, in defensive mode, the surveillance unit is configured to detect if another individual is conducting surveillance in a given location, and whether that individual is stationary or moving. The individual may be on foot (in which case, the surveillance unit attempts to detect his or her WiFi connection on a mobile phone), on a motorcycle or motorbike, or in a four-wheeled vehicle. For example, the surveillance unit may be positioned next to a Jewish school to see if one or more individuals in one or more vehicles are patrolling near the school in preparation for a malicious attack. In another example, the surveillance unit may be placed in the rear of a VW's wife's vehicle to make sure no individual is following her in preparation for a kidnapping attempt. If any individual conducting surveillance is detected, the surveillance unit can send out an alert in real-time or near real-time.

In at least an additional embodiment, in the defensive mode, a tracker vehicle may be detected at text box 320, and the vehicle details can be added to a report at text box 321 and/or to an accumulated list at text box 322. If the tracker vehicle is seen again (e.g., according to a time and distance indicated in the list) (diamond 324), the surveillance unit may raise a defensive alert at text box 326.

In at least an additional embodiment, if an object is targeted in intelligence mode (diamond 330), the surveillance unit can raise an intelligence alert at text box 350. The unit can also continue the tracking at text box 352 and record the targeted object's details in a report at text box 356.

In at least an additional embodiment, if the target object stays in-frame (diamond 360), the targeted object's details can be recorded in a “lost sight” list at text box 362. When the targeted object is out of frame at text box 364, a “lost sight” alert can be raised.

In at least an additional embodiment, if the object is not targeted (diamond 330), the object details can nonetheless be recorded in a report at text box 345.

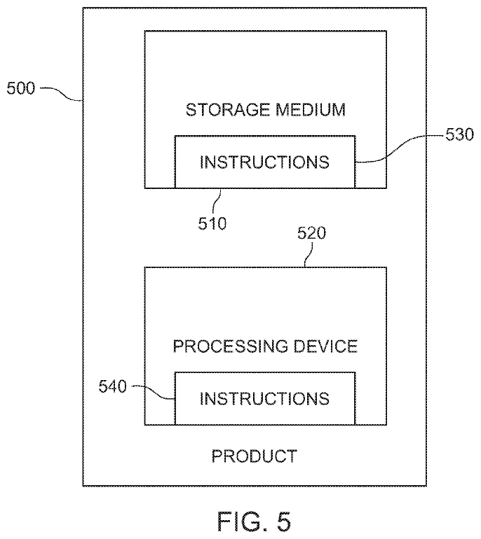

Turning now to FIG. 5, a schematic illustration is shown of a product of manufacture 500, according to at least one embodiment of the present disclosure. Product 500 includes one or more tangible computer-readable non-transitory storage media 510, which may include computer-executable instructions 530, implemented by processing device 520, and, when executed by at least one computer processor, enable the processing circuitry (e.g., as shown in FIG. 1) to implement one or more program instructions. Such program instructions may be for (1) surveillance of an object, and/or (2) performing, triggering, and/or implementing one or more operations, communications, and/or functionalities described above herein with reference to FIGS. 1-4.

In at least one embodiment, product 500 and/or machine-readable storage medium 510 may include one or more types of computer-readable storage media capable of storing data, including, for instance, volatile memory, non-volatile memory, removable or non-removable memory, erasable or non-erasable memory, writeable or re-writeable memory, and the like. For example, machine-readable storage medium 510 may include any type of memory, such as, for example, random-access memory (RAM), dynamic RAM (DRAM), read-only memory (ROM), programmable ROM (PROM), erasable programmable ROM (EPROM), electrically erasable programmable ROM (EEPROM), flash memory, a hard disk drive (HDD), a solid-state disk drive (SDD), a fusion drive, and the like. The computer-readable storage media may include any suitable media involved with downloading or transferring a computer program from a remote computer to a requesting computer carried by data signals embodied in a carrier wave or other propagation medium through a communication link (e.g., a modem, radio, or network connection).

In at least another embodiment, processing device 520 may include logic. The logic may include instructions, data, and/or code, which, if executed by a machine, may cause the machine to perform a method, process, and/or operations as described herein. The machine may include, for example, any suitable processing platform, computing platform, computing device, processing device, a computing system, processing system, computer, processor, or the like, and may be implemented using any suitable combination of hardware, software, firmware, and the like.

In at least a further embodiment, processing device 520 may include, or may be implemented as, software, firmware, a software module, an application, a program, a subroutine, instructions, an instruction set, computing code, words, values, symbols, and the like. Instructions 540 may include any suitable types of code, such as, for instance, source code, compiled code, interpreted code, executable code, static code, dynamic code, and the like. Instructions may be implemented according to a predefined computer language, manner or syntax, for instructing a processor to perform a specific function. The instructions may be implemented using any suitable high-level, low-level, object-oriented, visual, compiled, and/or interpreted programming language (e.g., C, C++, C#, Java, Python, BASIC, MATLAB, assembly language, machine code, and the like).

It should be appreciated that the embodiments, implementations, and/or arrangements of the systems and methods disclosed herein can be incorporated as a software algorithm, application, program, module, or code residing in hardware, firmware, and/or on a computer useable medium (including software modules and browser plug-ins) that can be executed in a processor of a computer system or a computing device to configure the processor and/or other elements to perform the functions and/or operations described herein.

It should further be appreciated that, according to at least one embodiment, one or more computer programs, modules, and/or applications that, when executed, perform methods of the present disclosure, need not reside on a single computer or processor, but can be distributed in a modular fashion amongst a number of different computers or processors to implement various aspects of the systems and methods disclosed herein.

Thus, illustrative embodiments and arrangements recited in the present disclosure provide a computer-implemented method, computer system, and computer program product for processing code(s). The flowchart and block diagrams in the figures illustrate the architecture, functionality, and operation of possible implementations of systems, methods, and computer program products according to various embodiments and arrangements. In this regard, each block in the flowchart or block diagrams can represent a module, segment, or portion of code, which comprises one or more executable instructions for implementing the specified logical function(s).

These and other objectives and features of the invention are apparent in the disclosure, which includes the above and ongoing written specification.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

The invention is not limited to the particular embodiments illustrated in the drawings and described above in detail. Those skilled in the art will recognize that other arrangements could be devised. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. While the invention has been described with reference to specific illustrative embodiments, modifications and variations of the invention may be constructed without departing from the spirit and scope of the invention as set forth in the following claims.

### EXAMPLES

Example 1: In Example 1, a surveillance system is disclosed that comprises at least one computer comprising at least one processor operatively connected to at least one non-transitory, computer readable medium, the at least one non-transitory computer readable medium having computer-executable instructions stored thereon, wherein, when executed by the at least one processor, the computer executable instructions carry out a set of steps defining: performing detection and/or surveillance over a predefined period of time to gather two or more surveillance data types from two or more sensors in order to generate gathered data; identifying a target and one or more properties of the target based on at least part of the gathered data at a first point of the period of time; and identifying the target at a second point of the period of time based on the one or more properties of the target identified at the first point of the period of time.

Example 2: In Example 2, the subject matter of Example 1 is included, and further, optionally, the set of steps additionally comprises: identifying the target and the one or more properties of the target using, at least in part, one or more artificial intelligence (AI) processes.

Example 3: In Example 3, the subject matter of one or more of the aforementioned examples is included, and further, optionally, the target comprises a motorcycle rider, and the one or more properties of the target comprises at least one of: a helmet, a rear image of a motorcycle being ridden by the motorcycle rider, a wireless signature of a cellphone of the motorcycle rider, and facial detection of the motorcycle rider. The facial detection may comprise one or more facial images or facial properties.

Example 4: In Example 4, the subject matter of one or more of the aforementioned examples is included, and further, optionally, the set of steps further comprises: identifying the target at the second point in the period of time by comparing one or more image frames and/or features captured at the first point in the period of time and one or more image frames and/or features captured at the second point in the period of time to stored historical data. The historical data may be stored in, for instance, a memory of the surveillance system.

Example 5: In Example 5, the subject matter of one or more of the aforementioned examples is included, and further, optionally, the surveillance system comprises a stand-alone surveillance device.

Example 6: In Example 6, a surveillance device is disclosed that comprises at least one computer comprising at least one processor operatively connected to at least one non-transitory, computer readable medium, the at least one non-transitory computer readable medium having computer-executable instructions stored thereon, wherein, when executed by the at least one processor, the computer executable instructions carry out a set of steps comprising: performing detection and/or surveillance over a predefined period of time to gather two or more surveillance data types from two or more sensors in order to generate gathered data; identifying a target and one or more properties of the target based on at least part of the gathered data at a first point of the period of time; and identifying the target at a second point of the period of time based on the one or more properties of the target identified at the first point of the period of time.

Example 7: In Example 7, the subject matter of Example 6 is included, and further, optionally, the set of steps additionally comprises: identifying the target and the one or more properties of the target using, at least in part, one or more artificial intelligence (AI) processes.

Example 8: In Example 8, the subject matter of Example 6 and/or Example 7 is included, and further, optionally, the target comprises a motorcycle rider, and the one or more properties of the target comprises at least one of: a helmet, a rear image of a motorcycle being ridden by the motorcycle rider, a wireless signature of a cellphone of the motorcycle rider, and facial detection of the motorcycle rider. The facial detection may comprise one or more facial images or facial properties.

Example 9: In Example 9, the subject matter of Example 6, Example 7, and/or Example 8 is included, and further, optionally, the set of steps additionally comprises: identifying the target at the second point in the period of time by comparing one or more image frames and/or features captured at the first point in the period of time and one or more image frames and/or features captured at the second point in the period of time to stored historical data. The historical data may be stored in, for instance, a memory of the surveillance system and/or stand-alone surveillance device.

Example 10: In Example 10, the subject matter of Example 6, Example 7, Example 8, and/or Example 9 is included, and further, optionally, the device comprises a stand-alone surveillance device.

Example 11: In Example 11, a method of detection and/or surveillance is disclosed, the method comprising: performing detection and/or surveillance over a predefined period of time to gather two or more surveillance data types from two or more sensors in order to generate gathered data; identifying a target and one or more properties of the target based on at least part of the gathered data at a first point of the period of time; and identifying the target at a second point of the period of time based on the one or more properties of the target identified at the first point of the period of time.

Example 12: In Example 12, the subject matter of Example 11 is included, and further, optionally, the method comprises: identifying the target and the one or more properties of the target using, at least in part, one or more artificial intelligence (AI) processes.

Example 13: In Example 13, the subject matter of Example 11 and/or Example 12 is included, and further, optionally, the target comprises a motorcycle rider, and the one or more properties of the target comprises at least one of: a helmet, a rear image of a motorcycle being ridden by the motorcycle rider, a wireless signature of a cellphone of the motorcycle rider, and facial detection of the motorcycle rider. The facial detection may comprise one or more facial images or facial properties.

Example 14: In Example 14, the subject matter of Example 11, Example 12, and/or Example 13 is included, and further, optionally, the method comprises: identifying the target at the second point in the period of time by comparing one or more image frames and/or features captured at the first point in the period of time and one or more image frames and/or features captured at the second point in the period of time to stored historical data. The historical data may be stored in, for instance, a memory of the surveillance system.

What is claimed is:

1. A system for detection and/or surveillance, the system comprising:
one or more surveillance units for surveilling an area, wherein each of the one or more surveillance units comprises:
one or more visual sensors configured to obtain one or more images of a target in the area,
one or more audio sensors configured to obtain audio of the area,
one or more location sensors configured to obtain positional data regarding the target and/or the area, and/or
one or more network sensors and/or one or more antennas operably connected to one or more WiFi cards and/or one or more Bluetooth cards,
one or more dongles configured to communicate with one or more external networks,
one or more data storage devices,
one or more cooling units, and
one or more clocks and/or timers.

2. The system of claim 1, wherein the target is selected from the group consisting of: a vehicle, a portion of a vehicle, a person, an animal, a ship or other watercraft, and combinations thereof.

3. The system of claim 1, wherein the one or more images include information selected from the group consisting of: a vehicle's make, a vehicle's model, a vehicle's color, and a vehicle's license plate, and combinations thereof.

4. The system of claim 1, wherein each of the one or more surveillance units further comprises one or more movement sensors configured to detect movement of at least one of the one or more surveillance units.

5. The system of claim 1, wherein each of the one or more surveillance units further comprises at least one computer comprising at least one processor operatively connected to at least one non-transitory, computer readable medium, the at least one non-transitory computer readable medium having computer-executable instructions stored thereon, wherein, when executed by the at least one processor, the computer executable instructions carry out a set of steps comprising:
performing surveillance on the target and/or the area over a predetermined period of time,
identifying the target and one or more properties of the target based on data gathered at a first point in time in the predetermined period of time, and
identifying the target at a second point in time in the predetermined period of time based on the one or more properties.

6. The system of claim 5, wherein the identifying the target and one or more properties of the target is performed using one or more artificial intelligence (AI) processes.

7. The system of claim 5, wherein the target comprises a motorcycle rider, and wherein the one or more properties of the target is selected from the group consisting of: a helmet, one or more portions of a motorcycle being ridden by the motorcycle rider, a wireless signature of an electronic device of the motorcycle rider, and combinations thereof.

8. The system of claim 5, wherein the set of steps further comprises:
identifying the target at the second point in time by comparing (i) one or more image frames and/or features captured at the first point in time and one or more image frames and/or features captured at the second point in time with (ii) historical data stored on the one or more data storage devices.

9. The system of claim 5, wherein the gathered data comprises the one or more images, and wherein the one or more images include one or more portions of a vehicle other than the vehicle's license plate.

10. The system of claim 5, wherein the target is a person surveilling at least one of the one or more surveillance units.

11. The system of claim 5, wherein at least one of the one or more surveillance units is a surveillance device that is configured to operate without connection to a power grid.

12. The system of claim 11, wherein the surveillance device is placed in a moving vehicle, wherein the area is an area behind the moving vehicle, wherein the target is a pursuing vehicle traveling in the area behind the moving vehicle and/or a person inside the pursing vehicle, and wherein the one or more images include a license plate of the pursuing vehicle.

13. A surveillance device comprising:
at least one computer comprising at least one processor operatively connected to at least one non-transitory, computer readable medium, the at least one non-transitory computer readable medium having computer-executable instructions stored thereon, wherein, when executed by the at least one processor, the computer executable instructions carry out a set of steps comprising:
observing, by at least one visual sensor comprised on the surveillance device, an area;
capturing, by the at least one visual sensor, one or more images of the area at a first point in time;
identifying, by the at least one processor, both a two-wheeled vehicle and one or more properties of the two-wheeled vehicle based on the one or more images; and
identifying, by the at least one processor, the two-wheeled vehicle in the area at a second point in time based on the one or more properties, and
wherein the one or more properties does not comprise a license plate of the two-wheeled vehicle.

14. The surveillance device of claim 13, wherein the set of steps further comprises:
collecting, by one or more network sensors and/or one or more antennas operably connected to one or more WiFi and/or one or more Bluetooth cards comprised in the surveillance device, a WiFi identifier and/or a Bluetooth identifier from a person operating the two-wheeled vehicle; and
identifying, by the at least one processor, the person based on the WiFi identifier and/or the Bluetooth identifier.

15. The surveillance device of claim 14, wherein the one or more properties comprises a combination of one or more features of the two-wheeled vehicle and one or more features of the person.

16. The surveillance device of claim 13, wherein the computer executable instructions further define:
a user interface engine configured to generate and display a user interface for the surveillance device,
a communications engine configured to communicate with (i) the user interface engine, and (ii) a remote user of the surveillance device,
a vision processing engine configured to capture one or more images from the at least one visual sensor,
an audio processing engine configured to capture audio from at least one audio sensor comprised in the surveillance device, and
a system manger configured to communicate with, and obtain data from, the vision processing engine and the audio processing engine.

17. The surveillance device of claim 16, wherein the vision processing engine and the audio processing engine are both operably connected to one or more data repositories comprised in the surveillance device.

18. The surveillance device of claim 16, further comprising one or more batteries that provide a sole source of power for the surveillance device.

19. The surveillance device of claim 16, wherein the remote user communicates to the communications engine via a point-to-point direct connection between the remote user's electronic device and the surveillance unit.

20. The surveillance device of claim 16, wherein the user interface is configured to enable the remote user to start the surveillance device, to set up one or more operating parameters of the surveillance device, and to stop the surveillance device.

21. The surveillance device of claim 16, wherein the vision processing engine comprises:
a video processing engine configured to read a plurality of frames captured by the at least one visual sensor,
an object detector configured to run an object detection algorithm to detect one or more objects and one or more features of the one or more objects,
a filter and feature extractor configured to (i) extract the one or more features, (ii) filter the one or more features, thereby generating one or more filtered features, (iii) store the one or more features and/or one or more filtered features in a repository, and (iv) match the one or more features and/or the one or more filtered features to data stored in the repository,
a tracker configured to monitor the one or more objects and to assign object identifiers to the one or more objects,
a vehicle information detector configured to extract vehicle information from the one or more images,
a license plate detector and reader configured to run the object detection algorithm to detect one or more portions of a vehicular license plate and to read the one or more portions,
a Global Positioning System (GPS) engine configured to collect GPS location information from the one or more objects, and
a decision engine configured to send alerts, generate reports, and generate annotated videos.

22. The surveillance device of claim 21, wherein the repository is configured to store the one or more filtered features in a searchable data structure.

23. The surveillance device of claim 21, wherein the one or more features is selected from the group consisting of: type of object, probability of a type of object, bounding box, and combinations thereof.

24. The surveillance device of claim 21, wherein the object detection algorithm is a You Only Look Once (YOLO) algorithm.

25. The surveillance device of claim 21, wherein the assignment of object identifiers uses bounding box tracking and similarities of the one or more features.

26. The surveillance device of claim 21, wherein the filtration of the one or more features uses Principal Component Analysis (PCA).

27. The surveillance device of claim 21, wherein the decision engine is configured to send the alerts if the decision engine determines if an object in the one or more objects matches a target in a predetermined list of targets.

28. The surveillance device of claim 27, wherein the decision engine is configured to add objects with the assigned object identifiers to the generated reports.

29. The surveillance device of claim 28, wherein the annotated videos comprise license plate information merged into videos captured by the at least one visual sensor.

30. The surveillance device of claim 21, wherein the extraction of the vehicle information comprises filtering the one or more images using one or more blur detection algorithms, and wherein the vehicle information is selected from the group consisting of: vehicle make information, vehicle model information, vehicle color information, and combinations thereof.

31. A method for detection and/or surveillance, the method comprising:
using a surveillance unit to:
detect an object in an area,
obtain an object identifier for the object,
identify when the object is a vehicle,
determine when the object is a target of interest, and
when the object is a vehicle, activate either an intelligence mode or a defensive mode of the surveillance unit.

32. The method of claim 31, further comprising:
using the surveillance unit, in the intelligence mode, to:
send a first intelligence alert to a user of the surveillance unit when the vehicle is the target of interest,
track the vehicle,
generate a report on the vehicle's movements for the user, and
send a second intelligence alert to the user if the vehicle is out of frame of the surveillance unit for a predetermined period of time.

33. The method of claim 32, further comprising:
using the surveillance unit, in the intelligence mode, to:
gather information on the area,
wherein the information is selected from the group consisting of: a number of persons in the area, a number of vehicles in the area, a number of WiFi devices in the area, a number of WiFi networks in the area, license plates in the area, and combinations thereof.

34. The method of claim 31, further comprising:
using the surveillance unit, in the defensive mode, to:
track the vehicle,
generate a report on the vehicle's movements for a user of the surveillance unit,
determine whether the vehicle is seen again in the area, and
send a defensive alert to the user.

35. The method of claim 34, further comprising:
using the surveillance unit, in the defensive mode, to:
detect when an individual is conducting surveillance in the area,
track movement of the individual, and
determine whether the individual is on foot or in a vehicle.
